(19) United States
(12) Patent Application Publication
(10) Pub. No.: US 2017/0136947 A1
(43) Pub. Date: May 18, 2017

(54) EARLY WARNING METHOD, SYSTEM AND SERVER BASED ON SATELLITE POSITIONING

(71) Applicant: Leauto Intelligent Technology (BEIJING) Co. Ltd, Chaoyang District Beijing (CN)

(72) Inventor: Zhao ZHANG, Chaoyang District Beijing (CN)

(21) Appl. No.: 14/976,686

(22) Filed: Dec. 21, 2015

(30) Foreign Application Priority Data
Nov. 12, 2015 (CN) 201510771855.9

(51) Int. Cl. B60Q 9/00

(52) U.S. Cl. CPC B60Q 9/008

(57) ABSTRACT

The present disclosure discloses an early warning method, system and server based on satellite positioning. The method includes: receiving position information of a monitor terminal device, a monitored object terminal device and a vehicle in real time; calculating distances among a monitor, a monitored object and the vehicle in real time according to the received position information; and judging whether to send alarm information according to the calculated distances among the monitor, the monitored object and the vehicle. The method provided by the present disclosure can be used for accurately deducing possible dangerous situations of the monitor, the monitored object and the vehicle, and helping the monitor to master the situations in time to avoid dangers.

### CROSS-REFERENCE TO RELATED APPLICATIONS

The present disclosure is based upon and claims priority to Chinese Patent Application No. 201510771855.9, filed on Nov. 12, 2015, the entire contents of which are incorporated herein by reference.

### FIELD OF TECHNOLOGY

The present disclosure relates to the field of application technology of satellite positioning systems, and particularly relates to a vehicle and personnel early warning method, system and server based on a satellite positioning system.

### BACKGROUND

With the development of the automobile industry, vehicle safety and position relations between vehicles and personnel are paid more and more attention, especially in the present society, a lot of children are trapped in the vehicles while their parents are not aware; and when the vehicles are temporarily parked, the children are stolen by others, or suffocation and even life-threatening situations of the children happen in the vehicles.

The existing satellite positioning system includes the American GPS global positioning system (it has the advantages of mature technology and is still dominant); the Chinese ‘Beidou’ navigation satellite positioning system (having the advantages of interactivity and openness); and the Russian CLONSS (Glonass) global navigation satellite system (having very strong anti-interference ability).

A system using a GPS positioning satellite for positioning and navigating worldwide in real time is called the global positioning system and is referred to as GPS. GPS is an omnibearing, all-weather, all-time and high-precision satellite navigation system developed by the US Defense Department. It can provide low-cost and high-precision three-dimensional positions, speeds, accurate timing and other navigation information for global users, is an application model of the satellite communication technology in the navigation field, greatly improves the information level of the earth society, and forcefully promotes the development of digital economy.

The Beidou satellite navigation system is a global satellite navigation system developed by China. It is the third mature satellite navigation system after the American GPS global positioning system and the Russian Glonass global navigation satellite system (CLONSS). The Beidou satellite navigation system (BDS), the American GPS, the Russian GLONASS and the European Union GALILEO are suppliers which have been identified by the United Nations Satellite Navigation Commission. The Beidou satellite navigation system is composed of three parts, namely, a space segment, a ground segment and a user segment, can provide high-precision and high-reliability positioning and navigation timing services worldwide in all weathers and at all time, has short message communication capacity and initially has area navigation, positioning and timing ability, the positioning accuracy is 10 meters, the velocity measurement accuracy is 0.2 m/s, and the timing accuracy is 10 ns.

So far, with respect to the phenomenon that children are trapped in vehicles, no effective early warning method is available to help the parents to master the situations of the children timely, in order to avoid life dangers of the children.

### SUMMARY

In view of the aforementioned problems, an early warning method, system and server based on satellite positioning are provided for positioning positions of a monitor, a vehicle and a monitored object, confirming a position relationship and early warning based on the position information of satellite positioning.

According to one aspect of the present disclosure, an early warning method based on satellite positioning is provided, including:

receiving position information of a monitor terminal device, a monitored object terminal device and a vehicle in real time;

calculating distances among a monitor, a monitored object and the vehicle in real time according to the received position information; and

judging whether to send alarm information according to the calculated distances among the monitor, the monitored object and the vehicle.

According to another aspect of the present disclosure, a server is provided, including:

a receiving module, a calculating module, a judging module and a sending module;

the receiving module is used for receiving position information of a monitor terminal device, a monitored object terminal device and a vehicle in real time;

the calculating module is used for calculating distances among a monitor, a monitored object and the vehicle in real time according to the received position information;

the judging module is used for judging whether to send alarm information according to the calculated distances among the monitor, the monitored object and the vehicle; and

the sending module is used for sending the alarm information under the trigger of the judging module.

According to a third aspect of the present disclosure, an early warning system based on satellite positioning is provided, including: the aforementioned server, as well as a monitor terminal device, a monitored object terminal device and a vehicle.

The present disclosure further provides a server, comprising: a processor; and a memory for storing instructions executable by the processor; wherein the processor is configured to perform the following steps: receiving position information of a monitor terminal device, a monitored object terminal device and a vehicle in real time; calculating distances among a monitor, a monitored object and the vehicle in real time according to the received position information; and judging whether to send alarm information according to the calculated distances among the monitor, the monitored object and the vehicle, sending the alarm information when the calculated distances meet a preset distance, wherein the processor is further configured to perform the following steps: when the distances among the monitor, the monitored object and the vehicle are less than or equal to a preset short distance, determining not to send the alarm information.

The processor is further configured to perform the following steps: when the distances among the monitor, the monitored object and the vehicle are greater than or equal to a preset long distance, and the distance between the monitored object and the vehicle is less than or equal to the preset short distance, determining to send the alarm information to the monitor terminal device to prompt that the monitor has left the vehicle and the monitored object is still in the vehicle.

The processor is further configured to perform the following steps: judging whether receives information sent back by the monitor terminal device within a preset time, and if not, sending the alarm information to the monitor terminal device again.

The processor is further configured to perform the following steps: when the distances among the monitor, the monitored object and the vehicle are greater than or equal to the preset long distance, determining to send the alarm information to the monitor terminal device and the vehicle to prompt that the monitored object leaves the vehicle.

The processor is further configured to perform the following steps: receiving speed information of the vehicle in real time; and when judging that the vehicle speed is greater than or equal to a preset speed, the distance between the monitor and the monitored object is less than or equal to the preset short distance, and the distances between the vehicle and the monitor and the monitored object are gradually increased, determining to send the alarm information to the monitor terminal device to prompt that the vehicle is stolen.

The processor is further configured to perform the following steps: receiving information confirming that a vehicle is stolen sent by the monitor terminal device; and sending control information to the vehicle to control the vehicle.

The preset short distance is 5 m to 8 m, and the preset long distance is 30 m to 50 m.

The solutions provided by the present disclosure are used for obtaining the position information of the monitor terminal device, the monitored object terminal device and the vehicle in real time, calculating the distances among the monitor, the monitored object and the vehicle in real time according to the received position information, and triggering alarm of a dangerous situation in real time according to the calculated distances among the monitor, the monitored object and the vehicle, so as to prevent the situation that the monitored object is forgotten in the vehicle and guarantee the safety of the monitored object, thereby playing a certain role in daily family protection.

The aforementioned illustration is merely a summary of the technical solutions of the present disclosure, in order to understand the technical means of the present disclosure more clearly and to implement the technical means according to the contents of the description, and in order to make the aforementioned and other purposes, features and advantages of the present disclosure be more obvious and understandable, specific embodiments of the present disclosure are listed below.

### BRIEF DESCRIPTION OF THE DRAWINGS

By reading the following detailed description of preferred embodiments, various other advantages and beneficial effects are clear to those of ordinary skill in the art. The drawings are merely used for showing the purposes of the preferred embodiments, and are not deemed as limitations to the present disclosure. In the entire drawings, the same component is represented by the same reference symbol. In the drawings:

FIG. 1 shows a flowchart of an embodiment of an early warning method based on satellite positioning provided by the present disclosure;

FIG. 2 shows a functional block diagram of an embodiment of a server provided by the present disclosure;

FIG. 3 shows a functional block diagram of an embodiment of an early warning system based on satellite positioning provided by the present disclosure;

FIG. 4a shows a schematic diagram of a safety situation scenario in the present disclosure;

FIG. 4b shows a schematic diagram of a scenario in which a monitored object is forgotten in the present disclosure;

FIG. 4c shows a schematic diagram of a scenario in which the monitored object leaves a vehicle in the present disclosure;

FIG. 4d shows a schematic diagram of a scenario in which the vehicle is stolen in the present disclosure;

FIG. 5 shows a schematic diagram of early warning analysis provided by the present disclosure.

### DESCRIPTION OF THE EMBODIMENTS

Exemplary embodiments of the present disclosure will be described below in more detail with reference to the drawings. Although the exemplary embodiments of the present disclosure are displayed in the drawings, it should be understood that, the present disclosure can be implemented in a variety of forms and should not be limited by the embodiments illustrated herein. On the contrary, these embodiments are provided for understanding the present disclosure more thoroughly and completely delivering the scope of the present disclosure to those skilled in the art.

In the following embodiments of the present disclosure, a specific introduction is given in combination with the early warning scenarios as shown in

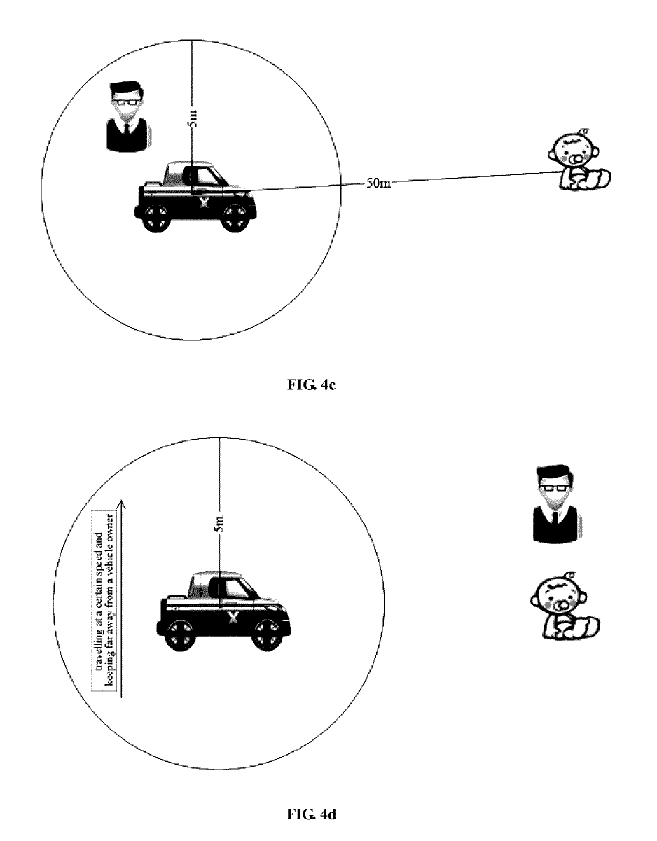

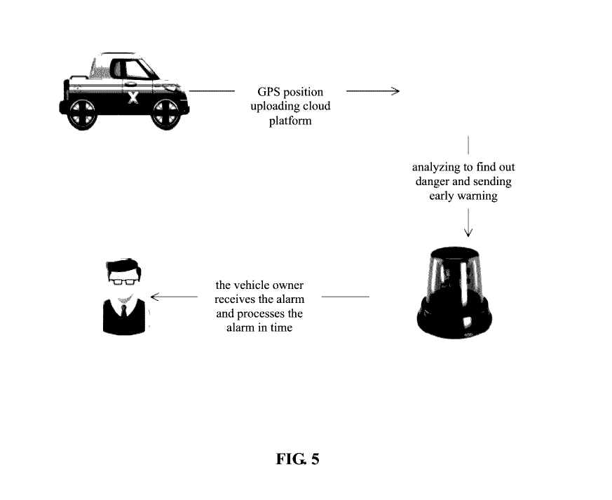

FIGS. 4a-4d and a framework of the early warning analysis method provided by the present disclosure as shown in FIG. 5.

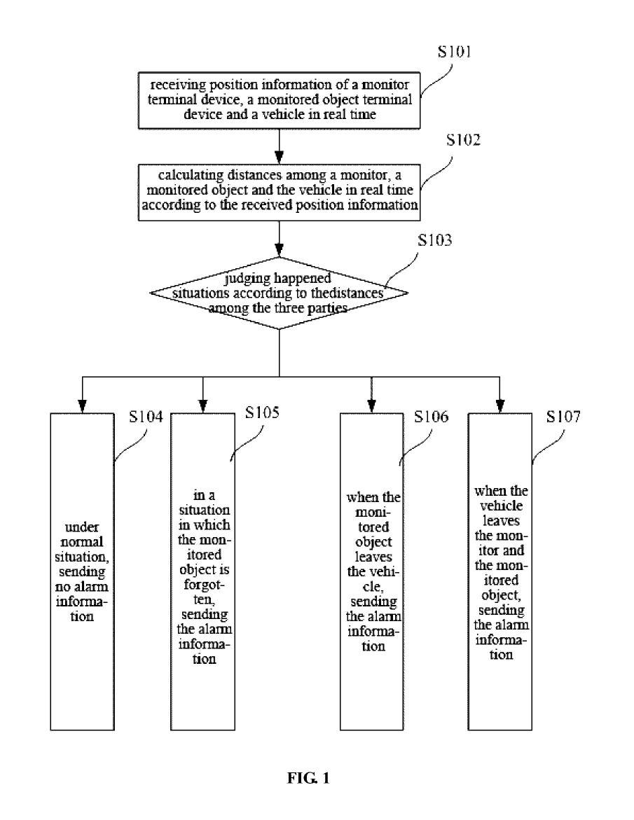

FIG. 1 shows a flowchart of an embodiment of an early warning method based on satellite positioning provided by the present disclosure. As shown in FIG. 1, the method specifically includes the following steps:

step S101, receiving position information of a monitor terminal device, a monitored object terminal device and a vehicle in real time; in the step, speed information of the vehicle can also be received in real time;

step S102, calculating distances among a monitor, a monitored object and the vehicle in real time according to the received position information;

step S103, judging which situation happens according to the calculated distances among the three parties and executing corresponding steps;

step S104, scenario 1: a normal situation

when a server detects that the distances among the monitor, the monitored object and the vehicle are within a preset short distance range by calculation, for example, when the distances among the monitor, the monitored object and the vehicle are within a range of smaller than or equal to 5 m, as shown in FIG. 4a, the server judges that both of the monitor and the monitored object are in the vehicle, determines that the situation is a normal situation and that no alarm is necessary, namely, the alarm information does not need to be sent to the monitor terminal device. Wherein, the preset short distance can be a numerical value between 5 m and 8 m, but is not merely limited to 5 m.

Step S105, scenario 2: a situation in which the monitored object is forgotten

When the monitor leaves the vehicle, the distances with the vehicle and the monitored object are greater than or equal to a preset long distance (for example, the distances from the monitor to the vehicle and the monitored object are greater than or equal to 50 m), and the distance between the monitored object and the vehicle is within the preset short distance range (for example, smaller than or equal to 5 m), as shown in FIG. 4b, the server obtains a conclusion that the monitor has left the vehicle and the monitored object is still in the vehicle, and at this time, the server sends alarm information to the monitor terminal device for early warning, so as to prompt that the monitor has left the vehicle and the monitored object is still in the vehicle. Wherein, the preset short distance can be a numerical value between 5 m and 8 m, but is not merely limited to 5 m; and the preset long distance can be a numerical value between 30 m and 50 m, but is not merely limited to 50 m.

Further, the server starts timing, when the situation is kept within a preset time (for example, 20 min) and the monitor does not reply any message, the server sends serious alarm information to the monitor terminal device again, to remind the monitor to confirm the situation in the vehicle and the reason.

Step S106, scenario 3: a situation in which the monitored object leaves the vehicle

In the case that the monitored object leaves the vehicle alone or is taken away or led away by others, when the server detects the positions of the three parties and finds that the distances between the monitored object and the monitor and the vehicle are greater than or equal to the preset long distance (for example, greater than or equal to 50 m), as shown in FIG. 4c, the server judges the occurrence of the situation that the monitored object leaves the vehicle, at this time, the server sends alarm information to the monitor terminal device and the vehicle, to prompt that the monitored object leaves the vehicle and that the position leaves away farther gradually, such that the monitor needs to confirm the situation. Wherein, the preset long distance can be a numerical value between 30 m and 50 m, but is not merely limited to 50 m.

Step S107, scenario 4: the vehicle leaves the monitor and the monitored object

When the server detects that the vehicle is moving at a certain speed (for example, greater than or equal to a preset speed, such as 30 km/h), the distance between the monitor and the monitored object is within the preset short distance (for example, smaller than or equal to 5 m), and the distances between the vehicle and the monitor and the monitored object are gradually increased, as shown in FIG. 4d, the server judges that the vehicle may be stolen, at this time, the server sends alarm information to the monitor terminal device, to prompt that the vehicle is stolen and require the monitor to confirm whether a vehicle is stolen, and if receiving information confirming that a vehicle is stolen sent by the monitor through the monitor terminal device, the server sends control information to the vehicle to carry out related operations on the vehicle as control and the like, for example, sending a deceleration or parking instruction, and after the vehicle receives the signal, a vehicle-mounted control system will decelerate the travelling speed of the vehicle or park the vehicle according to the signal. Wherein, the preset short distance can be a numerical value between 5 m and 8 m, but is not merely limited to 5 m.

In the present disclosure, whether the vehicle stolen situation may happen can also be judged by the following manner: when the server detects that the distance between the monitor and the monitored object is within the preset short distance (for example, less than or equal to 5 m), and the distances between the vehicle and the monitor and the monitored object are gradually increased, the server starts timing, calculates a position difference of the vehicle within a preset timing duration (for example, 10 s), divides the position difference with the preset timing duration to obtain the travelling speed of the vehicle, judges whether the travelling speed is greater than or equal to the preset speed, if so, judges that the vehicle may be stolen, and if not, considers that the vehicle is safe.

In the above embodiment, the server can be a cloud platform, such as a cloud server or the like, and can also be a traditional server; the vehicle can be a fuel vehicle, an electric vehicle, a hybrid electric vehicle or the like; the monitor can be a vehicle owner, a driver and other personnel; the monitored object can be a child, a mentally handicapped person and other personnel; the position information of the terminal device is provided by a satellite positioning system, such as a GPS, a Beidou navigation system or the like; the monitored object terminal device can be an intelligent terminal capable of positioning the location, such as a bracelet, a watch, paster, a mobile phone or the like; the monitor terminal device can be an intelligent terminal capable of positioning the location, such as a mobile phone, a PDA, a portable computer, a tablet computer or the like; the above alarm information can be a short message or a notification sent by the server to the monitor terminal device, to prompt the monitor of possible early warning situations, serious alarm refers to that the server dials the monitor terminal device, the monitor terminal device rings and displays the short message or the notification sent by the server and carrying the early warning situations, if the monitor does not confirm within a preset time, the monitor terminal device continuously rings, and if the monitor still does not confirm within a certain time, the server can dial 110 to alarm.

The method provided by the embodiment is used for obtaining the position information of the monitor terminal device, the monitored object terminal device and the vehicle in real time, calculating the distances among the monitor, the monitored object and the vehicle in real time according to the received position information, and triggering alarm of a dangerous situation in real time according to the calculated distances among the monitor, the monitored object and the vehicle, so as to prevent the situation that a child is forgotten in the vehicle and guarantee the safety of the child, thereby playing a certain role in daily family protection.

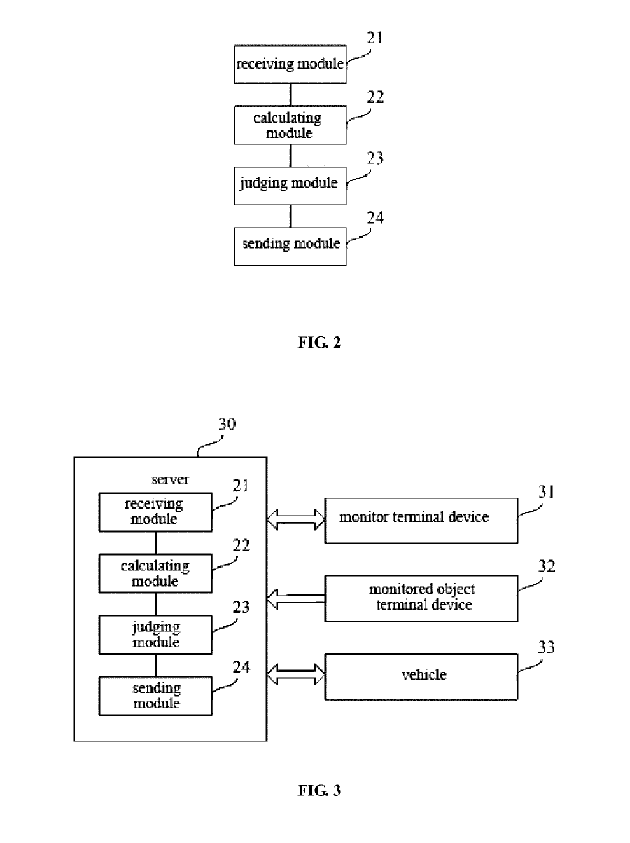

FIG. 2 shows a functional block diagram of an embodiment of a server provided by the present disclosure. As shown in FIG. 2, the server includes: a receiving module 21, a calculating module 22, a judging module 23 and a sending module 24.

The receiving module 21 is used for receiving position information of a monitor terminal device, a monitored object terminal device and a vehicle in real time; and the receiving module 21 is also used for receiving the speed information of a vehicle in real time;

the calculating module 22 is used for calculating distances among a monitor, a monitored object and the vehicle in real time according to the received position information;

the judging module 23 is used for judging whether to send alarm information according to the calculated distances among the monitor, the monitored object and the vehicle; and

the sending module 24 is used for sending the alarm information under the trigger of the judging module 23.

For the normal situation in scenario 1:

The judging module 23 is further used for: when judging that the distances among the monitor, the monitored object and the vehicle are less than or equal to a preset short distance range, for example, when the distances among the monitor, the monitored object and the vehicle are within a range of being less than or equal to 5 m, judging the situation as a normal situation, and sending no alarm information. Wherein, the preset short distance can be a numerical value between 5 m and 8 m, but is not merely limited to 5 m.

For the situation in which the monitored object is forgotten in scenario 2:

The judging module 23 is further used for: when judging that the distances between the monitor and the vehicle and the monitored object are greater than or equal to a preset long distance (for example, the distances between the monitor and the vehicle and the monitored object are greater than or equal to 50 m), and the distance between the monitored object and the vehicle is within the preset short distance range (less than or equal to 5 m), judging to obtain a conclusion that the monitor has left the vehicle and the monitored object is still in the vehicle. At this time, the judging module 23 triggers the sending module 24 to send alarm information to the monitor terminal device for early warning, so as to prompt that the monitor has left the vehicle and the monitored object is still in the vehicle. Further, the judging module 23 judges whether the receiving module 21 receives information sent back by the monitor terminal device within a preset time, and if not, triggers the sending module 24 to send the alarm information to the monitor terminal device again. For example, the judging module starts timing, if the situation is kept for more than 20 minutes and corresponding information sent by the monitor terminal device is not received, the sending module 24 sends serious alarm to the monitor terminal device and requires the monitor to confirm the situation in the vehicle and the reason. Wherein, the preset short distance can be a numerical value between 5 m and 8 m, but is not merely limited to 5 m; and the preset long distance can be a numerical value between 30 m and 50 m, but is not merely limited to 50 m.

The monitored object leaves the vehicle in scenario 3:

In the case that the monitored object leaves the vehicle alone or is taken away or led away by others, the judging module 23 is further used for: when judging that the distances between the monitored object and the monitor and the vehicle are greater than or equal to the preset long distance (for example, greater than or equal to 50 m), obtaining a conclusion that the monitored object is not in the vehicle. The judging module 23 triggers the sending module 24 to send alarm information to the monitor terminal device and the vehicle, to prompt that the monitored object leaves the vehicle and inform the monitor that the monitored object is not in the vehicle and the position leaves away farther gradually, such that the monitor needs to confirm the situation. In this case, corresponding alarm information is displayed on a screen in the vehicle, or the vehicle can also simultaneously or singly send alarm sound. Wherein, the preset long distance can be a numerical value between 30 m and 50 m, but is not merely limited to 50 m.

The vehicle leaves the monitor and the monitored object in scenario 4:

The judging module 23 is further used for: when judging that the vehicle is moving at a certain speed (for example, greater than or equal to a preset speed, such as 30 km/h), the distance between the monitor and the monitored object is within the preset short distance (for example, less than or equal to 5 m), and the distances between the vehicle and the monitor and the monitored object are gradually increased, judging that the vehicle may be stolen. The judging module 23 triggers the sending module 24 to send alarm information to the monitor terminal device to carry out vehicle stolen alarm and require the monitor to confirm whether a vehicle is stolen, if the receiving module 21 receives information confirming that a vehicle is stolen sent by the monitor through the monitor terminal device, the sending module 24 sends control information to the vehicle to carry out related operations on the vehicle as control and the like, for example, sending a deceleration or parking instruction, and after the vehicle receives the signal, a vehicle-mounted control system will decelerate the travelling speed of the vehicle or park the vehicle according to the signal. Wherein, the preset short distance can be a numerical value between 5 m and 8 m, but is not merely limited to 5 m.

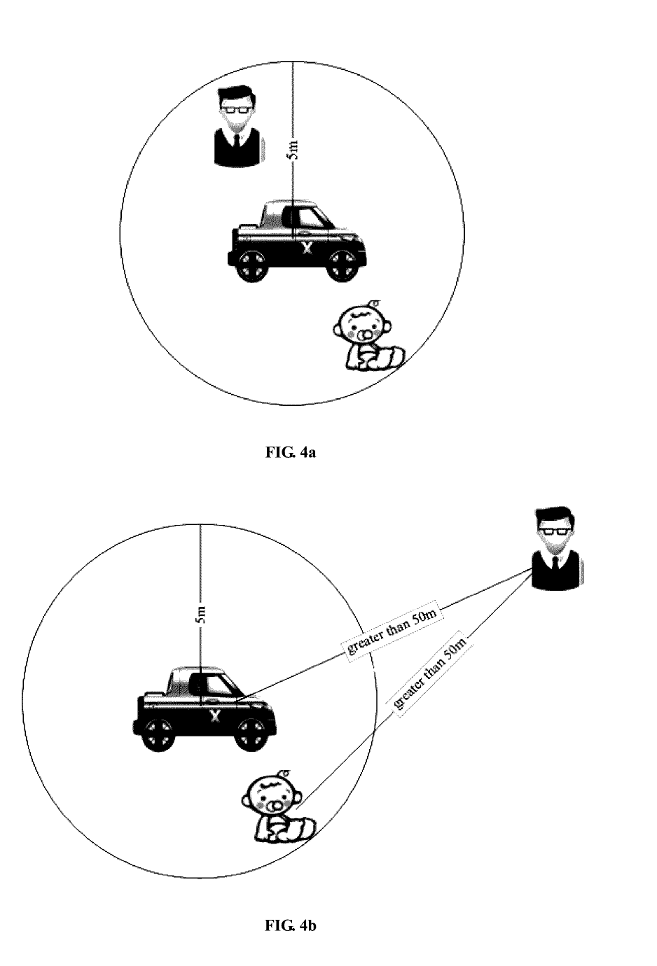

FIG. 3 shows a functional block diagram of an embodiment of an early warning system based on satellite positioning provided by the present disclosure. As shown in FIG. 3, the early warning system includes a server 30, a monitor terminal device 31, a monitored terminal device 32 and a vehicle 33. Wherein, for specific functions of the server 30, the monitor terminal device 31, the monitored terminal device 32 and the vehicle 33, please refer to descriptions in the above embodiment.

The present disclosure further provides a server, comprising: a processor; and a memory for storing instructions executable by the processor; wherein the processor is configured to perform the following steps: receiving position information of a monitor terminal device, a monitored object terminal device and a vehicle in real time; calculating distances among a monitor, a monitored object and the vehicle in real time according to the received position information; and judging whether to send alarm information according to the calculated distances among the monitor, the monitored object and the vehicle, sending the alarm information when the calculated distances meet a preset distance, wherein the processor is further configured to perform the following steps: when the distances among the monitor, the monitored object and the vehicle are less than or equal to a preset short distance, determining not to send the alarm information.

The processor is further configured to perform the following steps: when the distances among the monitor, the monitored object and the vehicle are greater than or equal to a preset long distance, and the distance between the monitored object and the vehicle is less than or equal to the preset short distance, determining to send the alarm information to the monitor terminal device to prompt that the monitor has left the vehicle and the monitored object is still in the vehicle.

The processor is further configured to perform the following steps: judging whether receives information sent back by the monitor terminal device within a preset time, and if not, sending the alarm information to the monitor terminal device again.

The processor is further configured to perform the following steps: when the distances among the monitor, the monitored object and the vehicle are greater than or equal to the preset long distance, determining to send the alarm information to the monitor terminal device and the vehicle to prompt that the monitored object leaves the vehicle.

The processor is further configured to perform the following steps: receiving speed information of the vehicle in real time; and when judging that the vehicle speed is greater than or equal to a preset speed, the distance between the monitor and the monitored object is less than or equal to the preset short distance, and the distances between the vehicle and the monitor and the monitored object are gradually increased, determining to send the alarm information to the monitor terminal device to prompt that the vehicle is stolen.

The processor is further configured to perform the following steps: receiving information confirming that a vehicle is stolen sent by the monitor terminal device; and sending control information to the vehicle to control the vehicle.

The preset short distance is 5 m to 8 m, and the preset long distance is 30 m to 50 m.

In summary, the new early warning solution provided by the present disclosure has the following beneficial effects:

Coordinate positions of the vehicle, the vehicle owner and the child can be judged in real time.

Possible dangerous situations may be deduced according to different position relations of the three parties.

Early warning information is sent to a mobile phone terminal of the vehicle owner to carry out danger early warning.

Accidents caused by negligence or forget are effectively reduced.

The above description shows and describes several preferred embodiments of the present application, but as mentioned above, it should be understood that, the present application is not limited to the form disclosed in this paper, should not be considered as an exclusion to other embodiments, but can be applied to a variety of other combinations, modifications and environments and can be varied within the scope of inventive conception in this paper by means of the above instruction or technology or knowledge in related fields. Modifications and variations made by those skilled in the art do not depart from the sprit or scope of the present application and should fall into the scope of protection of appended claims of the present application.

What is claimed is:

1. An early warning method based on satellite positioning, comprising:
receiving position information of a monitor terminal device, a monitored object terminal device and a vehicle in real time;
calculating distances among a monitor, a monitored object and the vehicle in real time according to the received position information; and
judging whether to send alarm information according to the calculated distances among the monitor, the monitored object and the vehicle.

2. The method of claim 1, wherein the judging whether to send alarm information according to the calculated distances among the monitor, the monitored object and the vehicle further comprises: when the distances among the monitor, the monitored object and the vehicle are less than or equal to a preset short distance, determining not to send the alarm information.

3. The method of claim 1, wherein the judging whether to send alarm information according to the calculated distances among the monitor, the monitored object and the vehicle further comprises: when the distances among the monitor, the monitored object and the vehicle are greater than or equal to a preset long distance, and the distance between the monitored object and the vehicle is less than or equal to the preset short distance, determining to send the alarm information to the monitor terminal device to prompt that the monitor has left the vehicle and the monitored object is still in the vehicle.

4. The method of claim 3, further comprising: after sending the alarm information to the monitor terminal device, and if not receiving information sent back by the monitor terminal device within a preset time, sending the alarm information to the monitor terminal device again.

5. The method of claim 1, wherein the judging whether to send alarm information according to the calculated distances among the monitor, the monitored object and the vehicle further comprises: when the distances among the monitor, the monitored object and the vehicle are greater than or equal to the preset long distance, determining to send the alarm information to the monitor terminal device and the vehicle to prompt that the monitored object leaves the vehicle.

6. The method of claim 1, further comprising: receiving speed information of the vehicle in real time; and
the judging whether to send alarm information according to the calculated distances among the monitor, the monitored object and the vehicle further comprises: when judging that the vehicle speed is greater than or equal to a preset speed, the distance between the monitor and the monitored object is less than or equal to the preset short distance, and the distances among the monitor, the monitored object and the vehicle are gradually increased, determining to send the alarm information to the monitor terminal device to prompt that the vehicle is stolen.

7. The method of claim 6, further comprising:
when receiving information confirming that a vehicle is stolen sent by the monitor terminal device, sending control information to the vehicle to control the vehicle.

8. The method of claim 2, wherein the preset short distance is 5 m to 8 m.

9. The method of claim 3, wherein the preset long distance is 30 m to 50 m.

10. A server, comprising:
a processor; and
a memory for storing instructions executable by the processor;
wherein the processor is configured to perform the following steps:
receiving position information of a monitor terminal device, a monitored object terminal device and a vehicle in real time;
calculating distances among a monitor, a monitored object and the vehicle in real time according to the received position information;
judging whether to send alarm information according to the calculated distances among the monitor, the monitored object and the vehicle; and
sending the alarm information when the calculated distances meet a preset distance.

11. The server of claim 10, wherein the processor is further configured to perform the following steps: when the distances among the monitor, the monitored object and the vehicle are less than or equal to a preset short distance, determining not to send the alarm information.

12. The server of claim 10, the processor is further configured to perform the following steps: when the distances among the monitor, the monitored object and the vehicle are greater than or equal to a preset long distance, and the distance between the monitored object and the vehicle is less than or equal to the preset short distance, determining to send the alarm information to the monitor terminal device to prompt that the monitor has left the vehicle and the monitored object is still in the vehicle.

13. The server of claim 12, the processor is further configured to perform the following steps: judging whether receives information sent back by the monitor terminal device within a preset time, and if not, sending the alarm information to the monitor terminal device again.

14. The server of claim 10, the processor is further configured to perform the following steps: when the distances among the monitor, the monitored object and the vehicle are greater than or equal to the preset long distance, determining to send the alarm information to the monitor terminal device and the vehicle to prompt that the monitored object leaves the vehicle.

15. The server of claim 10, the processor is further configured to perform the following steps: receiving speed information of the vehicle in real time; and
when judging that the vehicle speed is greater than or equal to a preset speed, the distance between the monitor and the monitored object is less than or equal to the preset short distance, and the distances between the vehicle and the monitor and the monitored object are gradually increased, determining to send the alarm information to the monitor terminal device to prompt that the vehicle is stolen.

16. The server of claim 15, the processor is further configured to perform the following steps:
receiving information confirming that a vehicle is stolen sent by the monitor terminal device; and sending control information to the vehicle to control the vehicle.

17. The server of claim 11, wherein the preset short distance is 5 m to 8 m.

18. The server of claim 12, wherein the preset long distance is 30 m to 50 m.

19. An early warning system based on satellite positioning, comprising: the server of any of claim 10, as well as a monitor terminal device, a monitored object terminal device and a vehicle.
